(19) United States
(12) Patent Application Publication
(10) Pub. No.: US 2003/0230921 A1
(43) Pub. Date: Dec. 18, 2003

(54) Back support and a device provided therewith

(76) Inventor: George Gifeisman, Farmington, CT (US)

Correspondence Address: Ilya Zborovsky, 6 Schoolhouse Way, Dix Hills, NY, 11746, US

(21) Appl. No.: 10/142,014

(22) Filed: May 10, 2002

(51) Int. Cl. B60N 2/02

(52) U.S. Cl. 297/354.1

(57) ABSTRACT

An angular back support has two substantially hard plate-shaped elements, which are connected with one another along their one side and are arranged at an angle relative to one another, so that a user's back can be supported inside an angular space formed by the plate shaped elements, which run along the spine from the sitting surface (sitting bones) and above the shoulders or the back of the head; it can be separate, or installed in a device.

### BACKGROUND OF THE INVENTION

The present invention relates to back supports to be used in seats in cars, airplanes, buses, passenger couches, and chairs.

It is known that in order to support the back, for example, while a person sits at a desk, at a computer, in a car, plane, in a bus, some back supports are utilized which are installed on the corresponding chairs or seats. It is believed that the existing supports can be further improved.

### SUMMARY OF THE INVENTION

Accordingly, it is an object of the present invention to provide an angular back support, which is a further improvement of the existing supports.

In keeping with these objects and with others, which will become apparent hereinafter, the features of the present invention resides, briefly stated:

It has two plate-shaped elements, which are connected to one another along their sides and are arranged at an angle relative to one another, so that the back of a user can be supported simultaneously against both plate-shaped elements.

It supports the back of the user from the sitting surfaces (sitting bones or buttocks) and extends above the shoulders or back of the head.

It can be used separately or as a part of another device.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of the angular back support in accordance with the present invention;

FIG. 2 is a perspective view of the device provided with the inventive angular support.

### DESCRIPTION OF THE PREFERRED EMBODIMENTS

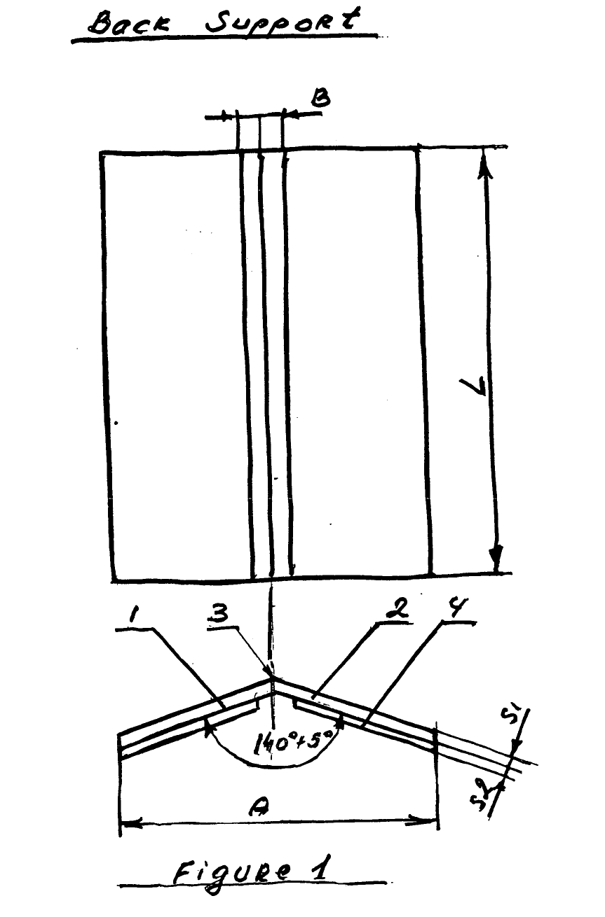

FIG. 1 shows an angular back support:

It includes two hard plate-shaped elements that are identified with reference numerals 1 and 2.

The plate-shaped elements are connected to one another at one of their sides at the location identified with reference numeral 3.

The angle between the plate-shaped elements is about 140-145 degrees.

The centerline located in area 3 divides the support into two symmetrical plate-shaped elements, like the wings of a butterfly. This angular feature allows inscribing into its open space a diversity of human bodies, supporting the back from the sides.

When the angular back support of the present invention is installed in a vertical direction it starts from the bottom, e.g. of a chair, and reaches above the shoulders or until back of the head, thus supporting the entire spine while sitting, which is identified with the reference letter L.

In accordance with a further embodiment of the present invention this plate shape elements composed:

1. From any kind of hard material, for example, from wooden flat plates with thickness identified with reference letter S1.

2. A cushion-like element, which identified with reference numeral 4, may be provided on an inner side of the back support, in other words one inner side of the plate-shaped elements 1, 2.

3. The cushion-like elements should have a limited thickness, which identified with the reference letter S2:

from ½ to ¾ of an inch for pure wool cloth;

from 1½ inch up to 2 inches for any other soft material, but in this case the thickness should diminish approaching the centerline area about 1½-2½ inches to the left and right of the centerline, which identified as the reference letter B.

Not only the angular back support in accordance with the present invention supports the back from both sides of the torso and from the sitting surface (sitting bones) and run above the shoulders or back of the head, but the angular shape along the spine and head provides:

1. Proper anatomical position of the spine and spinal column, thus allowing the muscles of the back to be relaxed without useless contraction and prevent the back muscles from exhaustion and tiredness. The proper anatomical position can be defined as the position of the body when strait line can be drawn from the opening of the ear, middle of the shoulder and hip joints.

2. Space to accommodate the protruding spinal column structures.

3. Space for the ventilation of the deep supporting and stabilizing muscles of the spinal column thus preventing overheating and over-relaxation of these muscles, as well as the prime muscular movers of the back.

4. Space to accommodate the changes of the spinal column and its curvatures in accordance with a 24-hour life cycle, when it shortens or lengthens.

With the invented angular back support a proper anatomical position will be maintained, since entire skeleton of the torso is supported in the invented angular back support. While sitting, such a position allows the muscles of the torso to be relaxed, thus avoiding their useless contraction. Such a position prevents the muscular contraction of the muscles of the torso thus preventing them from the exhaustion, muscular spasms and back pain attacks while using the seats in long-term traveling in cars, planes, buses, passenger couches, and chairs.

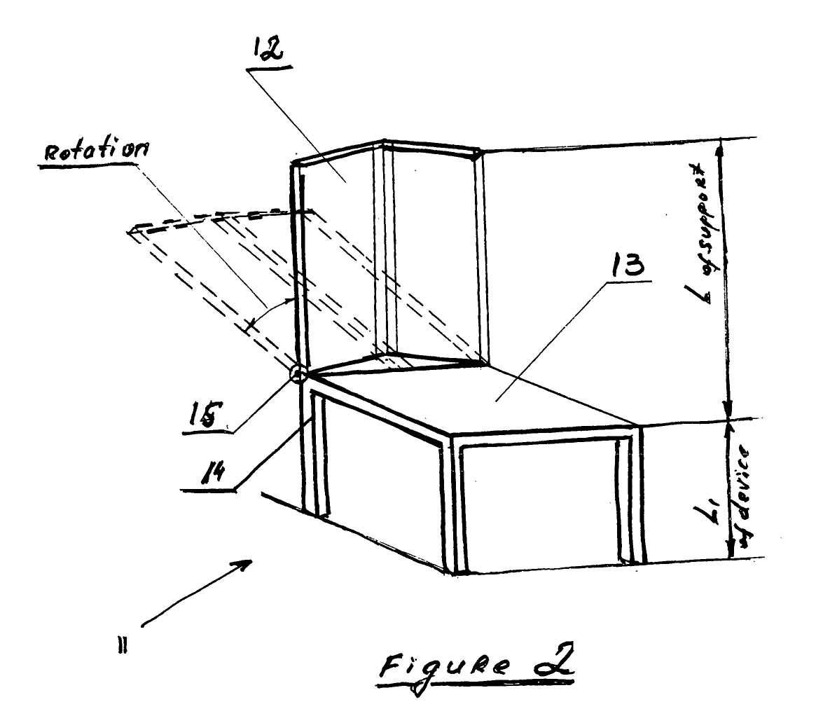

FIG. 2 shows another embodiment of the present invention:

1. A device, which is identified with reference numeral 11, e.g. a car seat or chair has a support, which is identified with reference numeral 12, which is formed in accordance with the invention and forms the back of the car seat or chair, a bottom seat, which is identified with reference numeral 13 and legs 14 which form a device part. The back support can be adjusted for sitting, sleeping, or resting positions by turning around an axis which is identified with reference numeral 15.

As can be seen from the drawing, the angular back support can be turned relative to other device part to assume a desired inclined position, for example for laying down.

It will be understood that each of the elements described above, or two or more together, may also find a useful application in other types of constructions differing from the types described above.

While the invention has been illustrated and described as embodied in an angular back support, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An angular back support, comprising two substantially hard plate-shaped elements, which are connected to one another along their sides and are arranged at the angle relative to one another, so that a user's back can be supported inside such angular space formed by the said plate-shaped elements.

2. An angular back support as defined in claim 1, wherein an angle between said plate-shaped elements is approximately 140-145 degrees.

3. An angular back support as defined in claim 1, wherein said plate-shaped elements support a spine from a sitting surface and runs above shoulders or a back of a head.

4. An angular back support as defined in claim 1, wherein said plate-shaped elements have an inner side to face a user's back; which has a cushion-like element.

5. An angular back support as defined in claim 1, wherein said cushion-like element has a limited thickness of about ½ to ¾ of an inch for a woolen cloth and up to 1½ inches for another appropriate material, but this cushion-like element should diminish when approaching a centerline started at 1-1½ inches to left and right of the centerline.

6. A device, comprising a device part; and an angular back support, which includes two substantially hard plate-shaped elements, which are connected to one another along their sides and are arranged at an angle relative to one another, so that a user's back can be supported inside such an angular space formed by the said plate-shaped elements, said device part supporting said angular back support.

7. A device, as defined in claim 6; and further comprising means for turning said angular back support relative to said device part, so that said angular back support can assume and inclined position relative to said device part.
